(19) United States
(12) Patent Application Publication
(10) Pub. No.: US 2008/0262786 A1
(43) Pub. Date: Oct. 23, 2008

(54) NON-EXERCISE ACTIVITY THERMOGENESIS (NEAT) GAMES AS UBIQUITOUS ACTIVITY BASED GAMING

(75) Inventor: Ioannis PAVLIDIS, Houston, TX (US)

Correspondence Address: CONLEY ROSE, P.C.;David A. Rose, P. O. BOX 3267, HOUSTON, TX, 77253-3267, US

(73) Assignee: THE UNIVERSITY OF HOUSTON SYSTEM, Houston, TX (US)

(21) Appl. No.: 12/106,720

(22) Filed: Apr. 21, 2008

Related U.S. Application Data
(60) Provisional application No. 60/912,831, filed on Apr. 19, 2007.

(51) Int. Cl. G01P 15/00

(52) U.S. Cl. 702/141

(57) ABSTRACT

A system for tracking physical activity comprising a sensor that detects movement carried by a first user, converts the movement into an electrical data signal and transmits the signal to a receiver, a receiver that transfers the movement data in the electrical data signal to a storage medium, and a processor that executes instructions to convert the movement data to a graphic representation of the first users movement. A method for monitoring physical activity, comprising attaching a sensor to a user wherein the sensor detects physical movement of the used and converts the physical movement into movement data indicative of the movement, transmitting and receiving the movement data signal, storing the movement data in a storage medium, and analyzing the movement data to monitor physical activity of the user.

### CROSS-REFERENCES TO RELATED APPLICATIONS

This application claims benefit of U.S. Provisional Application Ser. No. 60/912,831 filed on Apr. 19, 2007, entitled “Non-Exercise Activity Thermogenesis (NEAT) Games as Ubiquitous Activity Based Gaming” which is hereby incorporated herein by reference in its entirety.

### STATEMENT REGARDING FEDERALLY SPONSORED RESEARCH OR DEVELOPMENT

This invention was made with United States Government support under the U.S. National Science Foundation Grant Nos. IIS-0414754 The United States Government has certain rights in this invention.

### REFERENCE TO A SEQUENTIAL LISTING

Not applicable.

### BACKGROUND OF THE INVENTION

1. Field of the Invention

This invention relates to a method that combines unobtrusive physiologic sensing and novel Human-Computer Interaction (HCI) technologies for controlling obesity.

2. Background of the Invention

The importance of obesity to world health is without question. There are 1 billion people in the world who are overweight and 300 million with obesity. Recent work suggests that this is driven by a reduction in energy expenditure, rather than a rise in energy intake. In Britain where obesity has doubled since the 1980's, energy intake appears to have decreased.

Non-Exercise Activity Thermogenesis (NEAT) is the energy expenditure of all physical activities other than volitional sporting-like exercise. NEAT is highly variable among individuals. NEAT in an agricultural job exceeds that for an office job by 1,500 kcal/day. Similarly, an evening of television watching expends 30 kcal whereas an evening of gardening and walking the dog expends 600 kcal. Therefore, it is an object of the present invention to increase NEAT in the modern lifestyle. It leverages already ubiquitous gadgets (e.g., cell phones), unobtrusive metabolic measurement technology, and the entertainment appeal of computer gaming by developing a new breed of computer games catalyzed by human motion.

The behavioral effect of computer gaming has also caught the attention of the HCI community. It has been reported in an exploratory interview-based study of computer gaming that aspects of gaming most salient to gamers were those perceived to be most behaviorally relevant to goal attainment. Because video games are such a draw to young people, and people in general, it has been recommended that the use of video games can be used for healthful influence, not just for entertainment. For example, it has been suggested that dietetic professionals may add interactive, educational games to their ever growing repertoire of dietetic knowledge, skills, and patient/client education.

The cultural phenomenon created by the Dance-Dance Revolution (DDR) gaming has shown that playing DDR had a positive effect on the social life and physical health of players. Overall, researchers have started identifying the potential role that ubiquitous devices, like cell phones, can play in an HCI framework for battling obesity. Some have even tried to integrate ubiquitous sensing. However, integration is still weak and monitoring of energy expenditure relies in large part on user input. Also, the incentive scheme is based largely on warning and encouraging messaging. The effect of such messaging alone on people with behavioral problems is questionable.

Consequently, there is a need for a portable personal system to monitor and positively reinforce NEAT behaviors.

### BRIEF SUMMARY OF THE INVENTION

A system for tracking physical activity comprising a sensor that detects movement carried by a first user, converts the movement into an electrical data signal and transmits the signal to a receiver, a receiver that transfers the movement data in the electrical data signal to a storage medium, and a processor that executes instructions to convert the movement data to a graphic representation of the first users movement.

A method for monitoring physical activity, comprising attaching a sensor to a user wherein the sensor detects physical movement of the used and converts the physical movement into movement data indicative of the movement, transmitting and receiving the movement data signal, storing the movement data in a storage medium, and analyzing the movement data to monitor physical activity of the user.

The foregoing has outlined rather broadly the features and technical advantages of the invention in order that the detailed description of the invention that follows may be better understood. Additional features and advantages of the invention will be described hereinafter that form the subject of the claims of the invention.

### BRIEF DESCRIPTION OF THE FIGURES

FIG. 1 illustrates the NEAT system according to one embodiment of the invention.

FIG. 2 illustrates the NEAT sensor according to an embodiment of the invention.

FIG. 3 is a flow diagram of the NEAT system operation with one user according to an embodiment of the invention.

FIG. 4 is a flow diagram of the NEAT system operation with multiple users over a communications network according to an embodiment of the invention.

FIG. 5 is an illustration of the NEAT system on typical user.

FIG. 6A is a screen capture of one embodiment of a NEAT game.

FIG. 6B is a screen capture of one feedback remark according to an embodiment of the invention.

FIG. 7 illustrates the impact of a NEAT system on the energy expenditure of an individual.

### NOTATION AND NOMENCLATURE

Certain terms are used throughout the following descriptions and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DESCRIPTION OF THE PREFERRED EMBODIMENTS

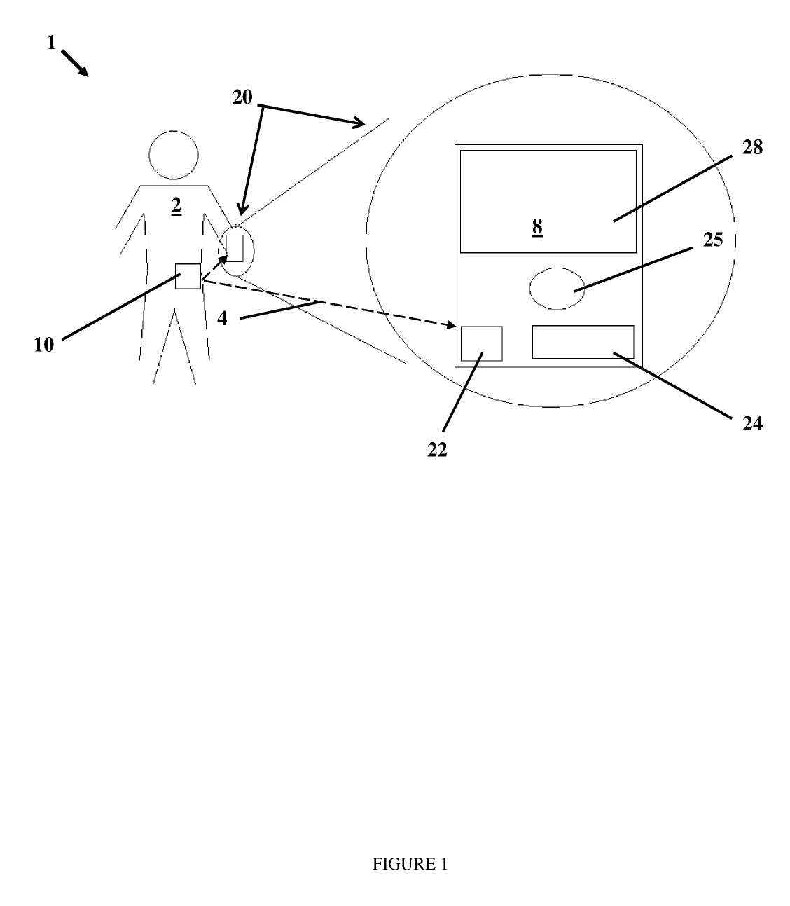

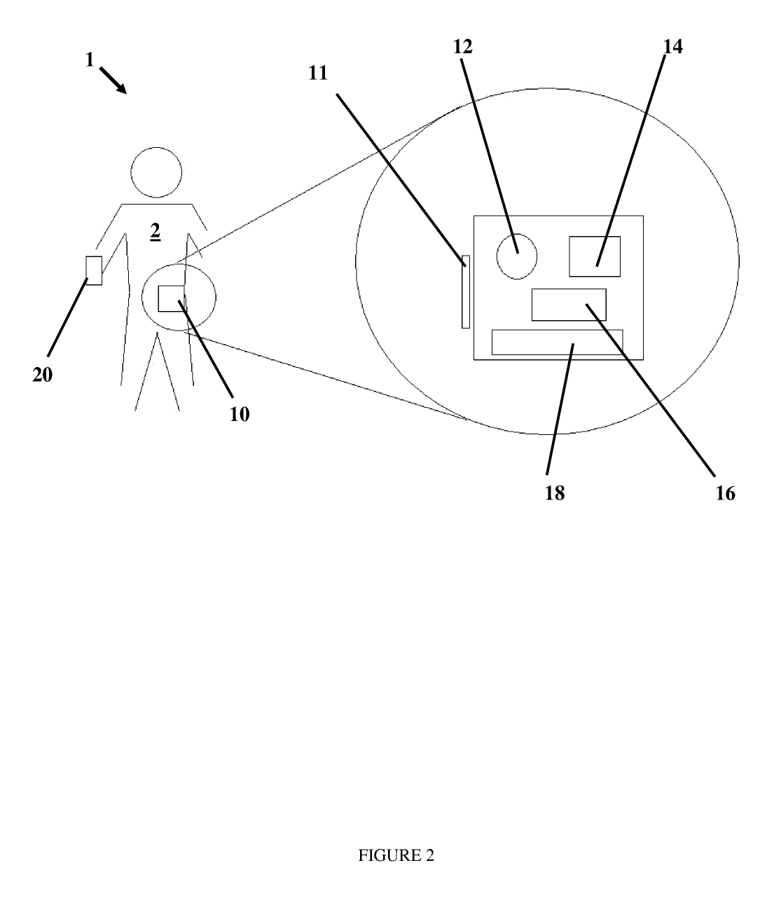

Referring to FIGS. 1 and 2, the NEAT (Non-Exercise Activity Thermogenesis) system 1, comprises a sensor system 10 that detects movement of a human user 2 and converts it to data signal 4. The sensor system 10 transmits movement data signal 4 to a Human-Computer Interaction (HCI) system. The HCI system comprises a handheld device 20 with a receiver 22 that receives the movement data signal 4, adds it to a storage medium 24, and a processor 25 that executes instructions from a program on the data 4 to display a user result 8 in display 28.

Sensor system 10 is small so that it does not interfere with human user 2 activities. The sensor system 10 is at largest about 6 cm by about 5 cm by about 3 cm in size. The sensor system 10 is wearable by the human user 2, comprising a clip or other fastener 11 without limitation for attachment to an article of clothing. The sensor system 10 comprises an accelerometer 12, a microcontroller 14, a transmitter 16 and a power supply 18. The accelerometer 12 is a device for converting motion into the electrical data signal 4 that is proportional to the acceleration value of the motion. The accelerometer 12 converting motion to electrical data signal 4 in at least one dimension or axis. In the sensor system 10 the accelerometer 12 converts motion to an electric signal 4 in three dimensions or axes. Microcontroller 14 is a computer processor for operating sensor system 10. Transmitter 16 transmits electrical data signal 4. Transmitter 16 comprises a short range transmitter, such as without limitation, an optical transmitter, a radio frequency transmitter or a magnetic field transmitter. Power supply 18 provides electrical energy to the sensor system 1. Power supply 18 comprises a battery, a photovoltaic cell, a mechanical power supply, a capacitor or combinations thereof. Human user 2 movement may provide a power supply 18 for sensor system.

The HCI system comprises a handheld device 20. The handheld device 20 comprises any commercially available personal electric device such as a personal digital assistance (PDA), a cell phone, or a personal music player without limitation. The handheld device 20 may comprise a personal electric device 20 configured for running the NEAT system 1, including a receiver 22, a storage medium 24, a display 28 and a processor 25 for executing instructions as known to one skilled in the art.

The handheld device 20 comprises at least one receiver 22, a storage medium 24, a display 28 and a processor 25. The receiver 22 for receiving a short range transmission such as without limitation an optical transmission, a radio frequency transmission or a magnetic field transmission. Further, the receiver 22 is configured to receive long range transmissions such as from a telecommunications network or a computer network. Alternatively, a plurality of receivers may be used to receive signals.

Storage medium 24 configured for storing and accessing data by the processor 25. Storage medium 24 may be any known to one skilled in the art. Storage medium 24 may comprise a plurality of storage devices.

Display 28 configured as a graphic user interface, wherein a user 2 can view, input and edit digital data. Display 28 may be any known to one skilled in the art. Display 28 may comprise a plurality of displays.

The sensor system 10 is worn by user 2 during daily tasks. Sensor system 10 converts user 2 daily movement into an electrical data signal 4. The sensor system 10 converts movement to a data signal 4 at a rate of at least four times per second. The data signal 4 is transmitted to the handheld device 20 at least once a second. The sensor system 10 conversion and transmission of data signal 4 is in real time. In certain instances the data signal 4 is briefly stored by microcontroller 14, when handheld device 20 is not capable of receiving the data signal 4. Further, microcontroller 14 may control transmission frequency to communicate with handheld device 20 when said device is operational. Handheld device 20 receives the data signal 4 at the rate it is transmitted from sensor system 10. The data signal 4 is stored on handheld device 20 by storage 24.

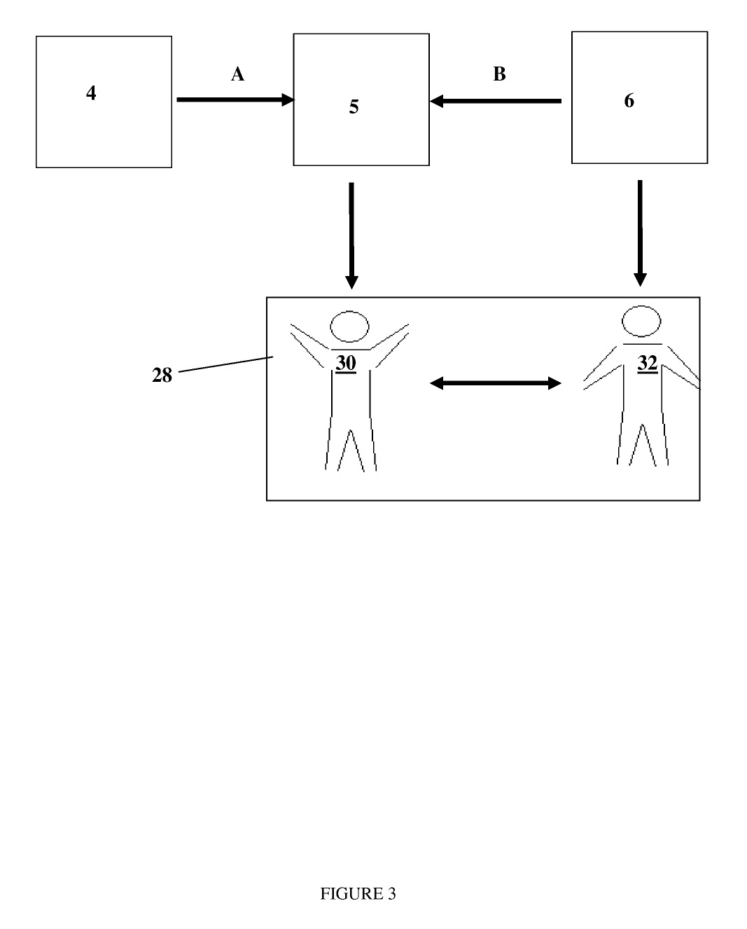

As illustrated in the diagram in FIG. 3 handheld device 20 comprising processor 25 includes instructions or a program 26 to execute on the data signal 4. In certain instances, data signal 4 is converted to units of energy, such as calories or kilocalories by processor 25 step A. The units of energy comprise movement data 5. As data signal 4 generation requires physical motion of user 2, the units of energy represent the energy expended by the user 2. Movement data 5 may comprise other data such as without limitation, duration, velocity, and direction of movement. In certain instances movement data 5 is compared to stored data 6 as in step B. Stored data 6 comprises artificial, simulated or previously stored user data without limitation.

Program 26 further instructs processor 25 to convert received data signal 4 to movement data 5 and previously stored data 6 into an avatar 30. Avatar 30 is a graphical representation of user 2. Program 26 instructs processor 25 to analyze the movement data 5 and display a result using avatar 30. Units of energy expended as calculated from movement data 5 are displayed by avatar 30, in comparison to previously stored data 6. Previously stored data 6 may be represented by a second avatar or computer avatar 31. Avatar 30 may be shown in display 28 in relation to an additional computer avatar 31, such that the avatar 30 is in competition with computer avatar 31 through the HCI system handheld device 20. In certain instances, a feedback message or prompt is triggered to positively reinforce continued movement. A feedback message may notify the user 2 that they are performing below, at, or above predetermined goals. Additionally, a feedback message may notify the user 2 of their performance relative to the stored data 6.

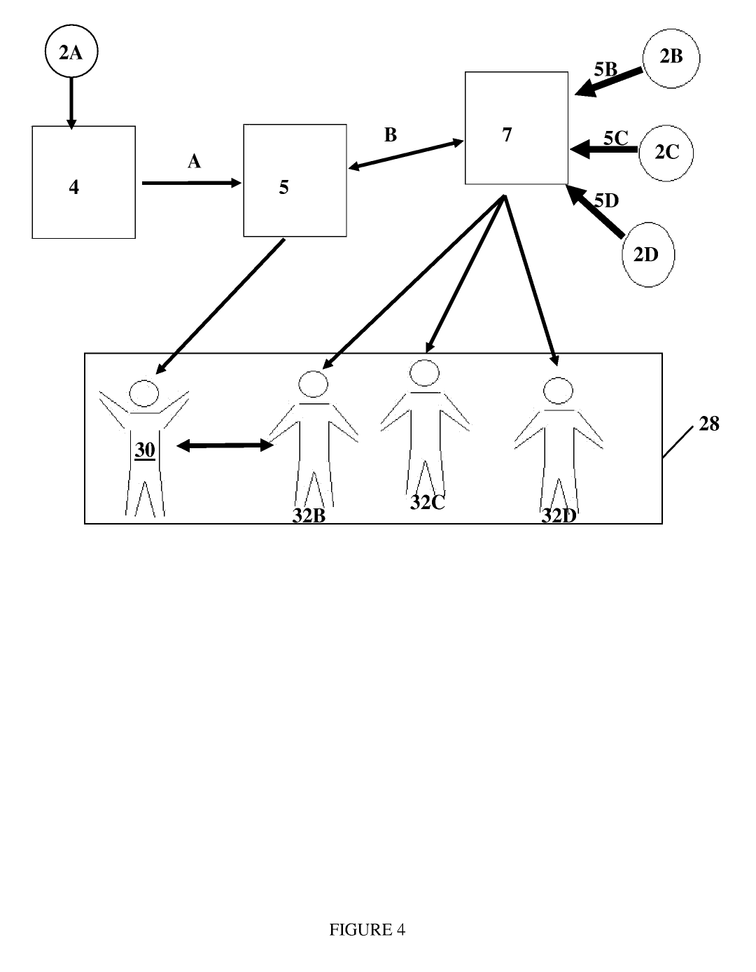

Alternatively illustrated in FIG. 4, a first user 2A generates an electrical data signal 4 that is converted to movement data 5 in step A. The movement data 5 is compared to network data 7 received from a telecommunications network in step B. The network data 7 places first user 2A is in competition with additional users 2B, 2C, 2D. Additionally, the first user 2A and the additional users 2B, 2C, 2D may be separated by a great distance. The additional users 2B, 2C, 2D can be considered remote competitors. Network data 7 comprises movement data 5B, 5C, 5D generated by additional users 2B, 2C, 2D. Movement data 5B, 5C, 5D generated by additional users 2B, 2C, 2D are further displayed as additional user avatars 32B, 32C, 32D in display 28. The first user 2A avatar 30 may be shown in relation to additional user avatars 32B, 32C, 32D in display 28. In certain instances, a feedback message or prompt is triggered to positively reinforce continued movement. A feedback message may notify the user 2 that they are performing below, at, or above predetermined goals. Additionally, a feedback message may notify the user 2 of their performance relative to the additional users 2B, 2C, 2D.

At a predetermined time period a winner may be declared in competition against stored data, or against additional users. A time period may comprise an hour, a period of the day, a complete day or longer as selected by the user. The winner is declared based on predetermined criteria. The criteria may comprise longest distance traveled, most movement, most units of energy consumed or any other physical activity parameter without limitation. The winner receivers certain positive reinforcements or rewards to continue movement, or activity. Positive reinforcements may be promotional considerations, virtual currency, logic puzzle hints or other rewards as known by one skilled in the art.

In embodiments where the program 26 is run using a commercially available handheld device 20, the program 26 operates in the background of other tasks. The program 26 operates such that the instructions to the processor 25 have a low priority. In further embodiments, the program 26 queues pop-up messages or alerts to gain the attention of the user 2. The alerts comprise a further feedback message.

To further illustrate various illustrative embodiments of the present invention, the following examples are provided.

### EXAMPLES

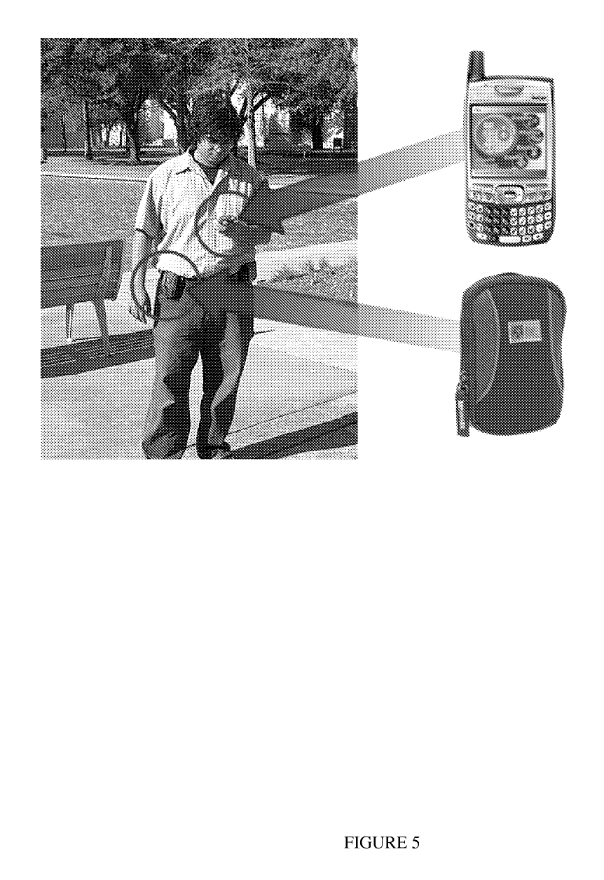

Generally, physical activity data is collected from small sensors worn by the user. The data collected from the activity sensors are logged via wireless connections to a Personal Digital Assistant/Cell Phone (PDA), which acts as the central computing unit of the system as shown in the FIG. 5 photograph. The data are processed through metabolic modeling software that computes the energy expenditure of the user in real-time. If the system projects energy expenditure below target levels, Human-Computer Interaction (HCI) mechanisms that promote NEAT (Non-Exercise Activity Thermogenesis) intensify feedback signals to the user to encourage increased physical activity.

A tri-axle accelerometer is used to measure physical activity. The form factor of the sensor is similar to a mobile phone and is attached to the waist of the user and communicates with a PDA through a Bluetooth connection. Measurements are recorded every second and are correlates of the energy expended by the user due to motion at the time. These expenditure data are being used in novel computer games that require physical activity. In the new generation of ubiquitous games, characters are being moved by activity data logged in by body-worn sensors (NEAT-o-games).

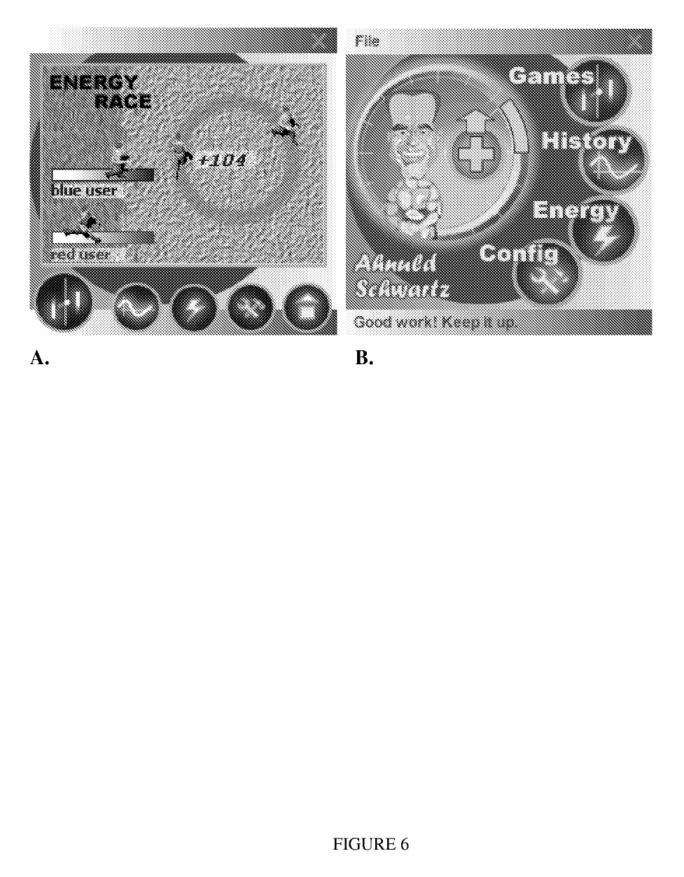

The first NEAT-o-game that can be played either between many people participating in a buddy list or between a single person and multiple computer-generated opponents. Every user is represented in the game as an avatar that runs around a circuit as illustrated in FIG. 6A example screen capture. Each avatar's motion is controlled by the accelerometer data logged from the waist sensor of the user. The most physically active user is ahead in the race. Furthermore, a selected celebrity avatar delivers real-time customized feedback as illustrated in the FIG. 6B example screen capture. Data communication between the users' PDAs participating in this competitive race is effected either through cellular broadband or Wi-Fi. Players in the game are notified periodically of their standing and a winner is proclaimed every day.

### Experimental Design and Results

A pilot experimental study for an initial evaluation of NEAT-o-Games was conducted after the approval of the local Institutional Review Board. Eight participants (7 males, 1 female) were recruited from the University of Houston (UH) campus. Prior to beginning the experiment all participants were requested to sign a consent form, read the NEAT-o-Games manual and fill in a pre-test questionnaire form, which asked questions concerning height, weight, and % body fat measured. During the experiment, participants' activity levels sensed with the NEAT-o-Games telemetry devices were recorded in the SQL server. At the end of the experiment, all participants were requested to fill in a post-test questionnaire.

The experiment consisted of 4 sessions. Each session included one weekday and one weekend day:
Session 1: Baseline Session. During this session, the participants were asked to carry around the NEAT-o-Games set (PDA+sensor). The system recorded their usual physical activity levels and the baseline was established.
Session 2: Emulator Session. The NEAT-o-Race simulated avatar option was activated. The player was represented by an avatar competing with a computer animated avatar in a virtual race. The rate of animation of the player's avatar was controlled by accelerometer data. The more the player moved the higher the rate of animation for the avatar which represented him/her in the virtual race. The pace of the simulated avatar was set to a level slightly lower of the recommended daily physical activity for an average person. Therefore, for the player to win the race, he/she had to complete at least the average daily physical activity quota.
Session 3: Energy Race. The human to human competitive option was activated. In that session the competitive avatar in the virtual race represented an actual player (“buddy”) from the player pool that participated in the study. For each duo, a daily winner was proclaimed based on the activity scores logged by the corresponding players.
Session 4: Sudoku. In that session, each participant played competitively against his/her buddy. However, the player had the option to spend activity points gathered during the daily race in exchange for help in the PDA-based Sudoku game. This helped the player to solve difficult Sudoku puzzles, but to make up spent points he/she had to be more physically active.

From the consent form and pre-test questionnaire, useful information about the profile of the participants was gathered. Specifically, the statistical mean and standard deviation of age, height, weight, percentage of fat, and Body Mass Index (BMI) for the participants were collected and computed in Table 1. The population sample was composed of primarily young people who were bordering the overweight category. According to WHO I classification [WHO 2007], people with:

19<BMI<25

are normal, while those with:

25<BMI<30

are overweight.

TABLE 1
Statistics of Physical Attributes

| Physical Attribute | Statistics (ⁿ⁼⁸) |
|---|---|
| Age (yr) | \hat{μ}ₐ = 28.1, \hat{σ}ₐ = 7.3 |
| Height (in) | \hat{μ}ₕ = 72.9, \hat{σ}ₕ = 2.7 |
| Weight (lbs) | \hat{μ}_{w} = 178.9, \hat{σ}_{w} = 29.3 |
| % fat | \hat{μ}_{f} = 21.2, \hat{σ}_{f} = 5.0 |
| BMI (kg/m) | \hat{μ}ᵢ = 24.3, \hat{σ}ᵢ = 3.9 |

Tabulation of other profile information from the participants' answers in the pre-test questionnaire is shown in Table 2. It includes information about computer savviness, computer game preferences, active/inactive lifestyle, work breaks, and initial attitude to the NEAT-o-Games concept. The participants were computer literate and played computer games occasionally. They also had a moderately active lifestyle, a normal working schedule, and a positive attitude towards NEAT-o-Games.

TABLE 2
Profile of UH Participants

88% of the participants knew what a Smartphone/PDA is.
Favorite computer games included: solitaire, minesweeper, snake,
bowling, and Baldur's gate.
The average time that the participants devoted on exercise was
around 5 hours per week.
75% of the participants had started an exercise plan in the past.
Out of those 67% stopped
within a month and the remaining within a year.
The main reason for abandoning the plan was motivation to keep up.
88% of the participants had lunch around noon, and the remaining
around 01:00 pm.
All participants went back to work after lunch.
75% of the participants left around 06:00 pm from their work place.
75% of the participants had dinner around 07:00 pm.
60% of the participants relaxed in their house before dinner.

An initial evaluation was run with four users to assess the robustness and usability of the system as well as obtain a first indicator of its behavioral impact. The users lived a mostly sedentary lifestyle, they were in their twenties and thirties, and on average they were overweight (BMI=26, WHO I classification). All users were PDA savvy. Each user completed three sessions on different days. Sessions were scheduled post-lunch or pre-dinner times when people often take a walk or watch television.

In session 1, each user was given a system (PDA and waist activity sensor) with the NEAT-o-game software disabled. The system simply recorded his activity and sent the data to a lab data server automatically.

In session 2, the user was allowed to play the NEAT-o-game, but only against a computer generated avatar, which was programmed to have an average activity level.

In session 3, the user played the NEAT-o-game against a human opponent. Users played this in pairs. Each user was equipped with a system, PDA and a waist activity sensor and selected each other to play the game through the user buddy list. Each system was communicating the data recorded by its sensor to the competitor's system through the cellular broadband. At the end of the session a winner was declared.

Each session lasted 45 minutes and completed at a different day, but at consistent times. For the two-user session, the two users were up to 15 miles apart. Every user completed pre- and post-study questionnaires based on the SUS usability instrument.

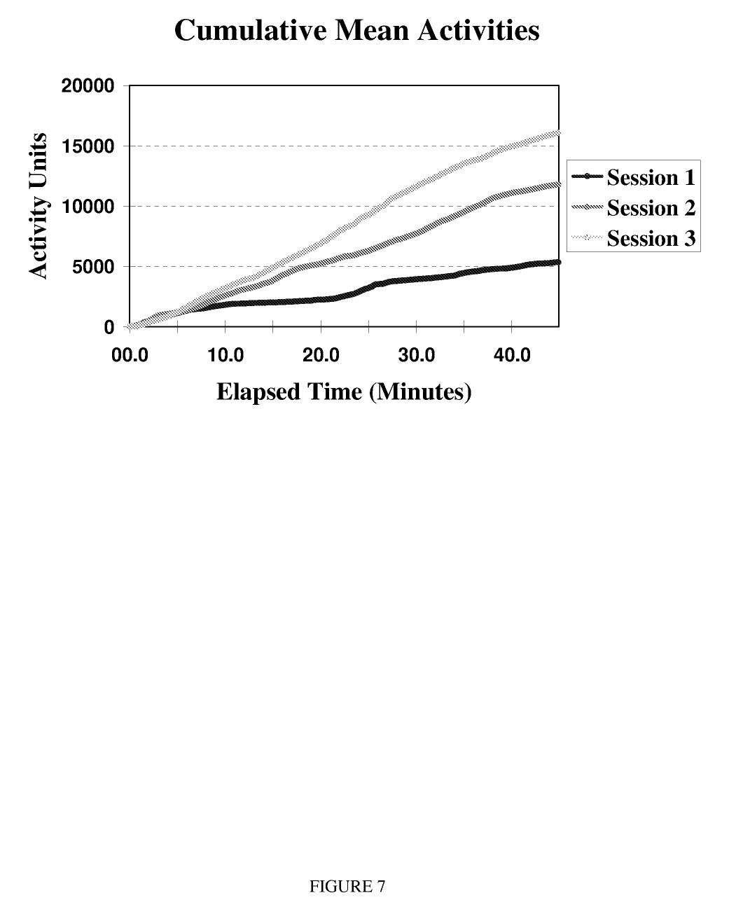

As shown in FIG. 7, addition of the computerized avatar greatly increased activity versus baseline. Moreover, activity increased further with a human opponent. All user activity was generated simply by walking in or around their offices and homes.

The post-session questionnaire focused on general usability questions, such as complexity and intuitiveness using a five-point Likert scale as well as open-ended questions. Based on a Kruskal-Wallis test there was no significant difference among the four users (p=0.8649), so results were combined. Scores for most questions were positive (i.e., 3.25-4). The only question with a negative response was whether the system could be used without any technical support (mean 2). However, this difference was not statistically significant. The open-ended questions revealed that the users loved the idea of NEAT-o-gaming, felt it would be helpful in a weight-loss program, and wanted more.

This prototype demonstrated both the feasibility and acceptability of the NEAT-o-games concept. Initial experiments with a small user set confirmed the robustness of the system operation even when users who played the game were physically miles apart. It also gave a first confirmation of the basic hypothesis that typically sedentary users enthusiastically embraced the game and played it with zest, much the same way one would expect them to play most other competitive computer games. Of course, due to the nature of the game, the side effect was higher physical activity. Feedback from the users was uniformly positive.

### User Interface

The guiding principles for the design of the game interface can be synopsized as follows:
Simple—This is a game on the go, and it is supposed to take place amidst other activities (e.g., walking).
Informative—The user should be able to get at a glance all that he/she needs to know.
Discreet—This game runs mostly in the background and does not interfere with normal tasks.
Motivating—The game supports a behavioral framework and facilitates motivation.
Elegant—This is a PDA application, one of the most competitive software domains.

Users are increasingly getting used to high quality mobile applications and anything clumsy by comparison will be a “turn-off.” Two sample screens are shown in FIG. 6.

Typically, the user runs the NEAT-o-game in the background while doing other tasks. A rallying screen pops-up to alert a user who is lagging behind the competition. It shows graphically in a dial the relative activity lag and a frustrated action figure. If the user is far ahead of the competition, then a congratulatory screen pops-up. The first action figure developed is a caricature of Arnold Schwarzenegger, as he is an ex-athlete turned politician and for this reason not only well-known but also semantically relevant. The user will choose from a roster of action figures such as Arnold as shown in FIG. 6B.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

We claim:

1. A system for tracking physical activity, the system comprising:
at least one sensor, wherein the sensor is carried by a first user, detects physical movement by said first user, and converts the movement into a signal containing data indicative of the movement;
a transmitter that transmits the signal;
a receiver that receives the signal and transfers the movement data contained in the signal to a storage medium; and
a processor that executes instructions to convert the movement data to a graphic representation of the first user's movement.

2. The system of claim 1, wherein the at least one sensor comprises a three axis accelerometer.

3. The system of claim 1, wherein the at least one sensor further comprises a global positioning system (GPS) receiver.

4. The system of claim 1, wherein the transmitter is a short range transmitter.

5. The system of claim 4, wherein the short range transmitter comprises at least one chosen from the group consisting of optical transmitters, radio frequency transmitters, and magnetic field transmitters.

6. The system of claim 1, wherein the storage medium contains simulated movement data.

7. The system of claim 1, wherein the processor compares the first user movement data to the simulated data.

8. The system of claim 1, wherein the receiver exchanges a signal containing the first user movement data with a communications network.

9. The system of claim 1, wherein the receiver transmits a signal comprising first user movement data to a communications network.

10. The system of claim 1, wherein the receiver is configured to receive a signal from a communications network, said signal comprising movement data from at least one alternate user.

11. The system of claim 10, wherein the receiver transfers the at least one alternate user movement data to a storage medium.

12. The system of claim 11, wherein the receiver differentiates the movement data from the first user, and the at least one alternate user prior to transfer to the storage medium.

13. The system of claim 1, wherein the processor compares the first user movement data and the at least one alternate user data.

14. The system of claim 13, wherein the processor displays a graphical comparison of the difference between the first user movement data and the at least one alternate user movement data.

15. The system of claim 1, wherein the processor delivers a reward based on the first user movement data.

16. A device for monitoring human activity, comprising at least one sensor, wherein said sensor is configured for
unobtrusive carriage on the person being monitored;
converting physical motion into an electrical signal; said sensor coupled to at least one microprocessor, at least one transmitter, configured for transmitting said electrical signal to a receiver.

17. The device of claim 16, wherein the at least one sensor comprises an accelerometer.

18. The device of claim 16, wherein the at least one sensor comprises a global positioning system (GPS) receiver.

19. The device of claim 16, wherein the at least one sensor is configured for attachment to a person's clothing.

20. The device of claim 16, wherein the transmitter is a wireless data transfer system.

21. The device of claim 20, where in the transmitter consists of at least one chosen from a group consisting of optical transmitters, radio frequency transmitters, and magnetic field transmitters.

22. The device of claim 16, wherein the sensor comprises a largest dimension of less than about 60 mm.

23. A method for monitoring physical activity, comprising:
attaching a sensor to a user, wherein the sensor detects physical movement of said user, converts said physical movement into movement data indicative of the movement;
transmitting the movement data signal;
receiving the movement data signal;
storing the movement data, wherein the data signal is transferred to a storage medium; and
analyzing the movement data to monitor the physical activity of the user.

24. The method of claim 23, wherein receiving the movement data signal further includes receiving at least one additional user movement data signal from a communications network and storing at least one additional user movement data on a storage medium.

25. The method of claim 23, wherein analyzing the movement data comprises comparing the movement data to data on the storage medium.

26. The method of claim 23, wherein analyzing the movement data comprises comparing the movement data to additional users movement data.

27. The method of claim 23, wherein analyzing the movement data further comprises converting the data signals into graphics.
